(19) United States
(12) Patent Application Publication
(10) Pub. No.: US 2011/0239949 A1
(43) Pub. Date: Oct. 6, 2011

(54) Hummingbird feeder

(76) Inventor: James Paul Abbott, Baton Rouge, LA (US)

(21) Appl. No.: 12/798,308

(22) Filed: Apr. 1, 2010

(51) Int. Cl. A01K 39/00

(52) U.S. Cl. 119/72

(57) ABSTRACT

A safety hummingbird feeder having a substantially cylindrical reservoir, an elongate feeding tube, and a cap. The reservoir has a reduced surface area and is intended to hold a limited amount of liquid sugar solution to reduce or eliminate spoilage and molding. The feeding port tube is made of soft, flexible material and may include a plurality of slits configured to prevent a withdrawing hummingbird from injuring its bill. The hummingbird feeder maximizes safety for a feeding humming bird by reducing or eliminating intestinal injury commonly caused by ingestion of spoiled and/or molded liquid sugar solution and the flexible feeding port tube minimizes the risk of bill injury for a retreating hummingbird.

### CROSS REFERENCES TO RELATED APPLICATION

Priority of U.S. Provisional Patent Application Ser. No. 61/166,742 filed Apr. 5, 2009, and incorporated herein by reference, is hereby claimed.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention relates to hummingbird feeders. More particularly, the present invention pertains to hummingbird feeders adapted to maximize safety for hummingbirds utilizing such feeders.

2. Brief Description of the Prior Art

Hummingbird feeders are commonly used to attract hummingbirds and dispense food to such animals. Although any number of different foods can be used, a nectar-simulating solution comprised of water and sugar is commonly used in most conventional hummingbird feeders. Such simulated nectar solution is typically stored in a container having some sort of an extended feeding tube. Hummingbirds using such a feeder must generally insert their bills through at least one narrow, elongated feeding tube in order to reach the simulated nectar solution located in the container.

In most cases, elongated feeding tubes of existing prior art hummingbird feeders are frequently made of a rigid material such as plastic, metal or glass. Moreover, such elongated feeding tubes are typically constructed of sufficient length to prevent bees and short-billed birds from reaching and feeding off the liquid solution stored in the container of the feeder.

Conventional prior art hummingbird feeders present several significant hazards for feeding hummingbirds. First, rigid elongated tubular openings of conventional prior art hummingbird feeders present safety concerns. It is well known that hummingbirds frequently attack each other during territorial disputes. Such attacks can force a feeding hummingbird to quickly retreat away from a feeder. In many cases, a hastily retreating hummingbird cannot completely withdraw its bill from a rigid opening before it attempts to escape laterally, thereby resulting in a cracked or broken bill. Such prior art hummingbird feeders do not give special consideration to the fragile nature of the long and slender hummingbird bill. Thus, the rigid feeding tube design of conventional hummingbird feeders puts a withdrawing hummingbird at a risk of injuring its fragile bill.

Second, existing prior art hummingbird feeders also present a risk of internal injury to hummingbirds resulting from ingestion of spoiled liquid sugar solution or other food. Conventional hummingbird feeders typically hold a relatively large quantity of simulated nectar solution, which solution can spoil before it can be consumed. Moreover, mold can also grow in such large capacity prior art feeders. Therefore, conventional hummingbird feeders having relatively large holding capacities must be frequently cleaned and refreshed in order to prevent harm to hummingbirds using such feeders. Failure to properly clean/refresh such existing prior art feeders can cause feeding hummingbirds to ingest spoiled or tainted food, thereby resulting in intestinal or other internal damage to such hummingbirds.

Accordingly, a longstanding need exists for a safer hummingbird feeder designed to reduce the chances of bill injury to hummingbirds using such feeder, while reducing the likelihood that such hummingbirds can be injured from ingesting spoiled and/or mold-tainted food such as, for example, nectar-simulating liquid sugar solution.

### SUMMARY OF THE PRESENT INVENTION

In the preferred embodiment, the hummingbird feeder of the present invention comprises a substantially cylindrical reservoir having at least one port, an elongated feeding tube connected to and in fluid communication with said at least one port, and a removable cap. Said cap can be beneficially removed to provide access to said reservoir, or installed to provide a liquid seal to close said reservoir.

The hummingbird feeder of the present invention maximizes safety for feeding hummingbirds, while minimizing risk of injury to a withdrawing or retreating hummingbird. In the preferred embodiment, the feeding tube of the present invention is soft and substantially flexible to permit a hummingbird to safely withdraw its bill from said feeding tube when the feeding process is completed, or when a quick retreat is required. In another preferred embodiment, the feeding tube of the present invention includes an external feeding end having at least one slit running substantially parallel to the longitudinal axis of said feeding tube. Said at least one slit is provided to increase flexibility of said feeding tube. Additionally, the hummingbird feeder of the present invention has a limited-capacity reservoir for holding a relatively small amount of food (such as, for example, nectar-simulating liquid sugar solution), thereby reducing likelihood of spoilage of such food or mold formation.

Because the hummingbird feeder of the present invention is inexpensive, a user can deploy multiple hummingbird feeders in a particular area to reduce and/or prevent the likelihood of a territorial dispute between birds using such feeders.

Thus, it is an object of the present invention to provide a hummingbird feeder that maximizes safety for feeding hummingbirds.

It is a further object of the present invention to provide a hummingbird feeder having a soft and flexible feeding tube that reduces the risk of hummingbird bill injury.

It is a further object still of the present invention to provide a hummingbird feeder having a relatively small food reservoir designed to reduce the likelihood of hummingbirds ingesting spoiled and/or molded food (including, but not limited to, liquid sugar solution).

It is another object of the present invention to provide a hummingbird feeder that can provide easy access to food for hummingbirds, while preventing bees, insects and short-billed birds from accessing such food.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed.

FIG. 1 depicts a perspective view of the hummingbird feeder of the present invention.

FIG. 2 depicts an exploded perspective view of the hummingbird feeder of the present invention.

FIG. 3 depicts a top view of the hummingbird feeder of the present invention.

FIG. 4 depicts a side section view of the hummingbird feeder of the present invention along line 4-4 of FIG. 3.

### DETAILED DESCRIPTION OF A PREFERRED EMBODIMENT OF THE INVENTION

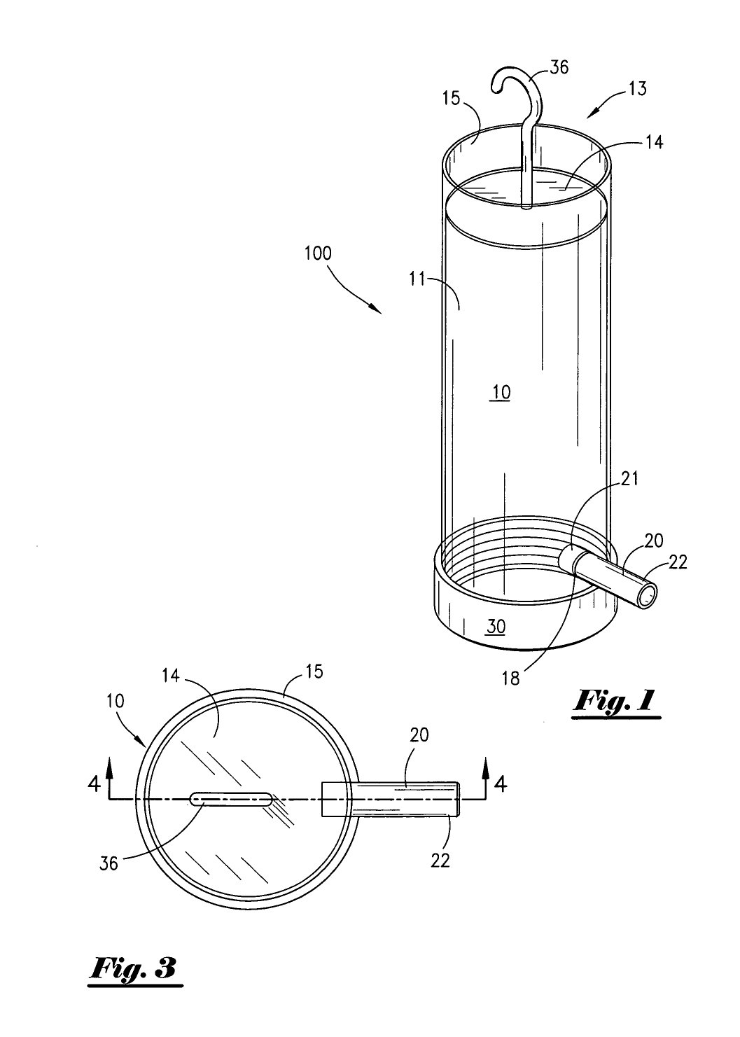

Referring now to the drawings, FIG. 1 depicts hummingbird feeder 100 of the present invention having a substantially cylindrical body member 10, elongated feeding tube 20, and cap 30. Substantially cylindrical body member 10 is at least partially hollow, thereby defining an inner chamber or void area (inner reservoir 11) within said body member 10. Said substantially cylindrical body member 10 has a recessed top end 13 defined by upper surface 14 and wall 15. Wall 15 and upper surface 14 form a cup that can hold water to provide a barrier to ants and other crawling insects. Hook 36 is connected to upper surface 14, and can be used to beneficially suspend or hang hummingbird feeder 100 at a desired location (such as, for example, from a tree branch).

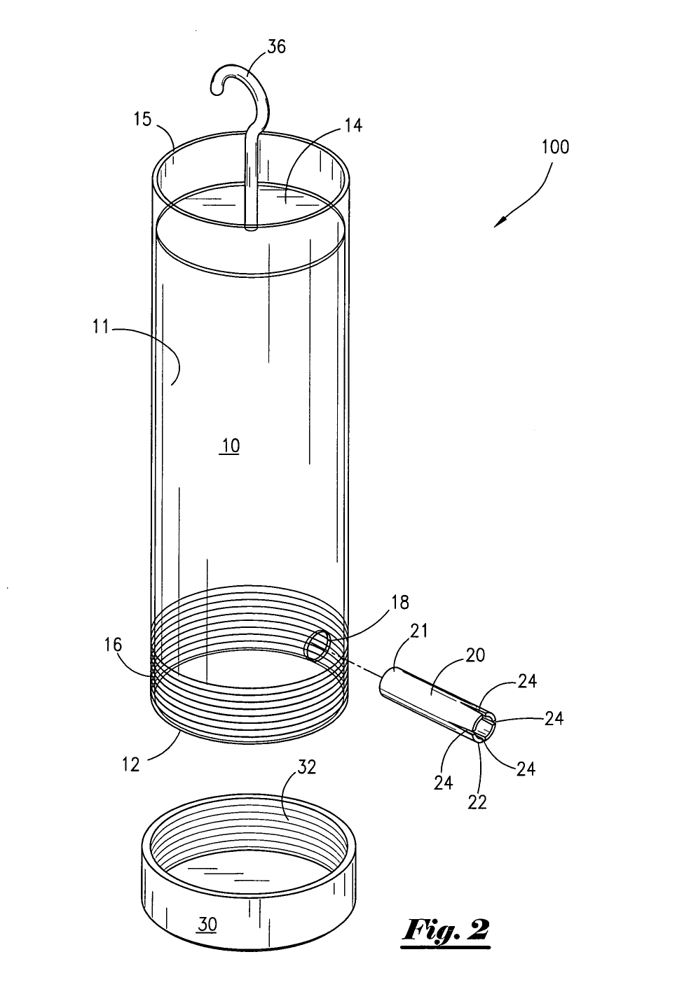

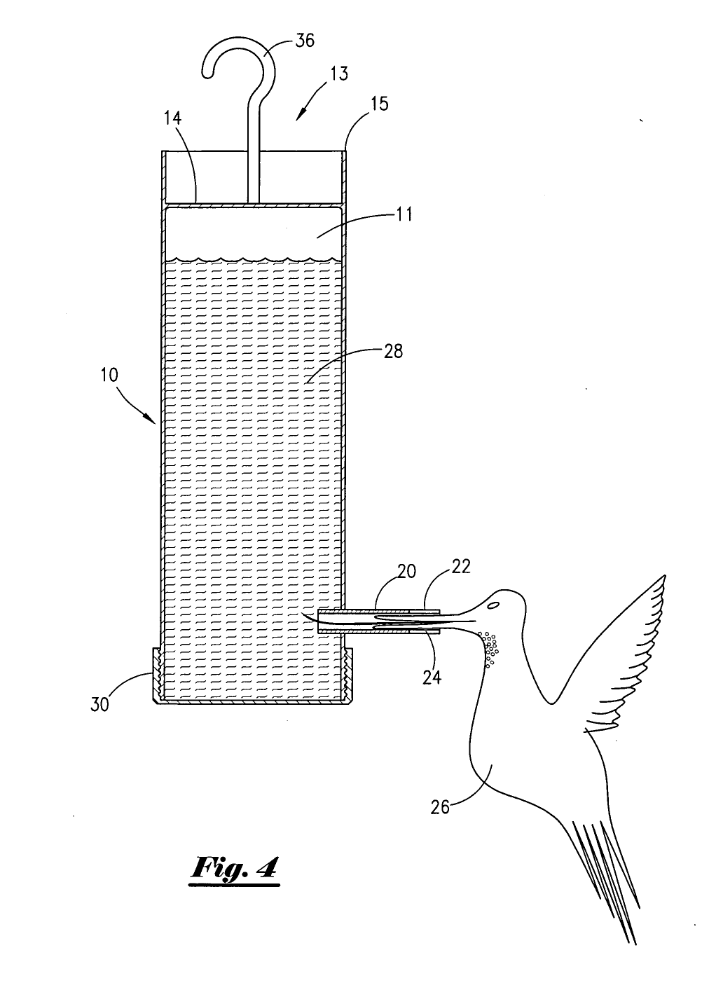

Still referring to FIG. 1, port 18 extends through substantially cylindrical body member 10. Elongated feeding tube 20 having supply end 21 and feeding end 22 is partially received within said port 18. In the alternative embodiment shown in FIG. 2, feeding end 22 of elongate feeding tube 20 has at least one slit 24 oriented substantially parallel to the longitudinal axis of said feeding tube 20.

Referring to FIG. 2, body member 10 has an open bottom end 12 and an enclosed top end 13. Open bottom end 12 opens into inner reservoir 11, and preferably includes external threads 16 to engage internal threads 32 disposed on the inner surface of the sides of cap 30. The engaged threaded connection between bottom end 12 and cap 30 effectuates a water tight seal to prevent liquid contents of reservoir 11 from leaking. Top end 13 is further provided with a hook member 36 for suspending hummingbird feeder 100 from a support structure (not shown) such as a tree limb, building or specially constructed stand.

Still referring to FIG. 2, body member 10 further includes port 18, proximate to threaded bottom end 12, for receiving supply end 21 of feeding port tube 20. The diameter of port 18 is slightly smaller than the external diameter of feeding tube 20, such that tube 20 can be forcibly inserted into said port 18, causing resilient feeding tube 20 to form a liquid seal with port 18. In effect, body member 10 (in the upright hanging position shown in FIG. 4) creates a partial vacuum to prevent the liquid solution 28 from leaking through the feeding port tube 20.

Still referring to FIG. 2, elongated feeding tube 20 is preferably made of soft, flexible material (such as, for example, silicone) to allow a hummingbird to safely withdraw its fragile bill from said feeding tube 20 without causing damage to such bill. Feeding tube 20 is of sufficient length to prevent access to food stored within inner reservoir 11 by bees, insects and/or short-billed birds while still allowing a hummingbird to feed.

Moreover, it is intended that the feeding tube 20 should be long enough such that a feeding hummingbird 26 keeps its bill outside inner reservoir 11, and yet is short enough to allow the tongue of a hummingbird 26 to reach liquid food solution 28 within said inner reservoir, as shown in FIG. 4. Experimentation has shown that feeding end 22 of a feeding tube 20 should beneficially be at least ¾ of an inch from the surface of liquid food solution 28 to effectively prevent access to bees, insects and/or short-billed birds, but no more than 1½ inches to enable a hummingbird 26 to access liquid food solution 28. Therefore, according to the preferred embodiment of the present invention, the flexible feeding tube 20 should be long enough to prevent access to liquid food solution 28 by unwanted animals, and of sufficient length that a feeding hummingbird 26 can keep its bill outside of inner reservoir 11 yet still reach liquid food solution 28.

In an alternative embodiment of the present invention, external feeding end 22 of feeding tube 20 may be further provided with a plurality of slits 24. These slits 24 allow the external feeding end 22 to aesthetically resemble a flower. Moreover, slits 24 are beneficially configured to increase the flexibility of external feeding end 22, thereby permitting a hummingbird to escape attack in any direction without injuring its bill. Thus, the inclusion of slits 24 in a second embodiment increases the attractiveness of the hummingbird feeder 100 and further increases flexibility of the feeding tube 20, and thereby further reduces the risk of bill injury.

Hummingbird feeder 100 is preferably constructed of durable materials having sufficient ultraviolet (“UV”) resistant properties. Body 10 can be molded using a thermoplastic such as polypropylene and is preferably translucent to facilitate visual inspection of inner reservoir 11 and any liquid contained therein to ensure proper operation and cleanliness. Cap 30 may also be made of a molded thermoplastic. In the preferred embodiment, cap 30 is preferably red in color to attract hummingbirds, rather than yellow, which has been proven to attract bees and other insects. The use of molded thermoplastics is a cost efficient process that produces inexpensive yet durable products.

Inner reservoir 11 of the presently preferred embodiment is intended to hold a limited quantity of liquid food solution 28. This limited holding capacity of the reservoir 11 reduces the probability of spoilage and mold-formation that is common with large capacity conventional hummingbird feeders. In particular, experimentation has suggested that feeders holding their solutions in reservoirs having a smaller surface area tend to maintain freshness longer than feeders storing solution in reservoirs having a greater surface area. Accordingly, the slim cylindrical design of body member 10 does greatly limit the surface area of the reservoir 11 to effectively reduce the probability of spoilage and mold-formation.

Furthermore, hummingbird feeder 100 of the present invention is inexpensive, thereby permitting users to deploy multiple limited capacity hummingbird feeders 100 rather than a single, large capacity feeder. The use of multiple limited capacity feeders 100 also effectively reduces the likelihood of a territorial dispute that commonly arises between hummingbirds competing for a single, large capacity feeder apparatus.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

The present invention is described primarily in the context of a feeder for hummingbirds. However it is to be readily observed that the present invention can be used for feeding other animals besides hummingbirds without departing from the scope of the present invention. Further, while the above description contains multiple references to nectar-simulating water/sugar solutions, it is to be observed that other flow-able food can also be used in conjunction with the present invention without limiting the scope of said invention.

What is claimed:

1. A hummingbird feeder comprising:
a. a substantially cylindrical and substantially hollow body member defining an inner reservoir, said body member having an open end, an enclosed end, and a feeding port extending through a side of said body member;
b. an elongated feeding tube having a first end and a second end, wherein said first end is connected to said feeding port;
c. a hook affixed to said enclosed end of said body member; and
d. a cap received on said open end of said body member.

2. A hummingbird feeder according to claim 1, wherein said open end of said body member includes external threads.

3. A hummingbird feeder according to claim 2, wherein said cap includes internal threads to engage the externally threaded open end.

4. A hummingbird feeder according to claim 1, wherein said elongated feeding tube is preferably made of soft, flexible material to allow a feeding hummingbird to safely withdraw its bill from the feeder.

5. A hummingbird feeder according to claim 1, wherein said elongated feeding tube includes an external feeding end having a plurality of slits oriented substantially parallel to the longitudinal axis of said feeding tube.

6. A hummingbird feeder according to claim 1, wherein said reservoir is substantially slim and configured so as to minimize the surface area of said reservoir.

7. A hummingbird feeder according to claim 1, wherein said feeding port has a diameter that is slightly smaller than the external diameter of said feeding tube such that said feeding port tube is forcibly received within said feeding port.

8. A hummingbird feeder according to claim 1, wherein said feeding tube is of sufficient length to permit a feeding hummingbird to keep its bill outside of said reservoir and yet is short enough to allow the tongue of said hummingbird to reach the contents of said reservoir.
